(19) United States
(12) Patent Application Publication
(10) Pub. No.: US 2007/0269690 A1
(43) Pub. Date: Nov. 22, 2007

(54) Control system, process and apparatus for hydrogen production from reforming

(76) Inventors: Kishore J. Doshi, Fernandina Beach, FL (US); John R. Harness, Elgin, IL (US)

Correspondence Address: Pauley Petersen & Erickson, Suite 365, 2800 West Higgins Road, Hoffman Estates, IL, 60169, US

(21) Appl. No.: 11/801,284

(22) Filed: May 9, 2007

Related U.S. Application Data
(60) Provisional application No. 60/802,357, filed on May 22, 2006.

(51) Int. Cl. H01M 8/06; B01J 8/00; C01B 3/38; C01B 3/50

(52) U.S. Cl. 429/19; 422/187; 422/211; 423/651

(57) ABSTRACT

A hydrogen generator contains a membrane separator and a pressure swing sorption system to produce two hydrogen product streams of differing purity. One of those streams is used as a feed to a fuel cell to generate electricity and the other is used as the primary hydrogen product.

### CROSS REFERENCE TO RELATED APPLICATION

This application claims the benefit of U.S. Provisional Patent Application No. 60/802,357, filed 22 May 2006.

### FIELD OF THE INVENTION

This invention pertains to control systems for operating reformers for the generation of hydrogen, to processes for reforming to produce a primary hydrogen product and electricity, and to apparatus therefore, and in particular to such processes purifying hydrogen generated by reforming through integrated membrane and pressure swing sorption unit operations.

### BACKGROUND TO THE INVENTION

Reforming of fuels is a well known process for generating hydrogen. Hydrogen is used for various purposes including as a chemical reactant, an annealing atmosphere and fuel to a fuel cell for generating electricity. Reforming processes include steam reforming, partial oxidation reforming and autothermal reforming, all of which use one or more catalysts.

As the fuels comprise components containing hydrogen and carbon such as hydrocarbons and oxygenated hydrocarbons, e.g., alcohols, ethers and the like, each of these types of reforming processes co-produce carbon oxides (carbon monoxide and carbon dioxide), the reformate is subjected to one or more unit operations to remove carbon oxides. Most often, the reformate is subjected to water gas shift conditions to generate additional hydrogen and carbon dioxide from carbon monoxide and steam contained in the reformate. The reformate may contain other impurities. For instance, with partial oxidation and autothermal reforming using air or oxygen enriched air, the reformate will contain nitrogen and argon.

The intended use for the hydrogen product defines acceptable hydrogen product compositions. For instance, where the hydrogen product is to be used as the fuel for a PEM-type fuel cell, the concentration of carbon monoxide, a poison to the fuel cell, is preferably less than about 10, more preferably less than about 5, ppmv (parts per million by volume). Nitrogen and carbon dioxide, in such applications, primarily act as diluents. The extent to which these components are removed is thus one of economics. Where hydrogen is used as an annealing atmosphere, the presence of carbon monoxide and carbon dioxide is generally not desired in that carbonization may occur under annealing conditions and adversely affect the work piece. In chemical processes, the specifications of the hydrogen will depend upon the nature of the process as well as any catalysts used therein.

Proposed methods for purifying reformates to provide a hydrogen product have included water gas shift, selective oxidation to oxidize carbon monoxide to carbon dioxide, thermal swing sorption, pressure swing sorption and selective permeation through a membrane. Selective permeation has not met with much commercial acceptance due to the combination of partial pressure differential driving force and membrane surface areas required for recovery of a desired percentage of hydrogen in the reformate. To reduce membrane surface area for a given percentage of hydrogen recovery, an increase in the partial pressure differential is required. Any compression of hydrogen-containing streams is energy intensive. Work, nevertheless, is continuing to develop suitable membranes. See, for instance, “Membranes for Gas Separation”, Chemical and Engineering News, Oct. 3, 2005, pp. 49 to 57, at pages 53 and 55.

Steam reforming of hydrocarbon-containing feedstock is a conventional source of hydrogen. Steam reforming of hydrocarbons is practiced in large-scale processes, often integrated with refinery or chemical operations. Thus, integrated reforming and chemical operations, due to their large scale and available skilled labor force, can rely upon sophisticated unit operations to economically produce hydrogen.

Hydrogen is difficult to store and distribute and has a low volumetric energy density compared to hydrocarbon-containing fuels. Thus, it is desirable to be able to generate hydrogen for use or distribution at a point proximate to the consumer such that a hydrocarbon-containing feedstock to the hydrogen generator is the material shipped and stored. However, the demand for hydrogen at such use or distribution points may be relatively small. Much greater challenges exist in producing hydrogen in smaller scale units than for the large industrial-scale hydrogen generators. Moreover, it is likely consumers who draw from a smaller scale hydrogen generator will not have constant demand. Hence, the hydrogen generator must be capable of changing hydrogen production rate.

Changing hydrogen production rates, however, is complex given the number of unit operations involved in reforming and purifying the reformate as well as the need to meet hydrogen product specifications including during the transition between hydrogen production rates. Where reformer outputs are intended to change, the use of partial oxidation reforming and autothermal reforming have been preferred since those types of reformers more readily lend themselves to changes than do steam reformers which must have the amount of externally provided heat change.

Heretofore it has been proposed to operate small reformers to generate electricity for, e.g., household use. When the electrical demand for electricity is down, the excess hydrogen could be stored, or more preferably used as a source of heat. Another proposal has been to divert a portion of the hydrogen product for generating electricity while the remaining portion of the purified reformate is used for alternative purposes such as for chemical operations. See, for instance, International Publication Number WO 2005/009892 A2, corresponding to International Publication Number PCT/US2004/23707. The problem, however, is that the entire reformate must be able to meet the stringent purity specifications required for most types of fuel cells.

### SUMMARY OF THE INVENTION

In accordance with this invention, a hydrogen generator is provided with two hydrogen purification systems for treating reformer effluent, one, a membrane separator, for providing hydrogen of a first purity and the other, a pressure swing sorption system, for providing hydrogen of a second purity. Only a fraction of the hydrogen in the feed to the membrane separator permeates the membrane, and those gases not permeating are provided to the pressure swing sorption system for additional recovery. Thus, by removing only a portion of the hydrogen as permeate in the membrane separator, an attractive driving force for permeation of hydrogen can be maintained such that lower membrane surface area is required for a given flux. Accordingly, the pressure of the reformate need not be compressed to provide an adequate partial pressure driving force across the membrane. Hence, the hydrogen generator and processes of this invention take advantage of a membrane separation to provide a hydrogen stream of a first purity while still achieving adequate hydrogen recovery through pressure swing sorption purification.

The invention is particularly useful where partial oxidation or autothermal reforming using air as the oxygen source provides the reformate hydrogen. Not only are these types of reforming more suitable than steam reforming where lower volumes of hydrogen product are sought, but also the hydrogen purification systems can handle the presence of nitrogen to provide suitable purity hydrogen products for fuel cell and for primary use applications.

The hydrogen from the membrane separation, i.e., the hydrogen of the first purity, will have a purity that in part relates to the selectivity of the membrane. The hydrogen from the membrane separation may be of higher or lower purity than that from the pressure swing sorption. The advantages of having two separately purified hydrogen products are multifold. One of the products can be of appropriate purity for use as a fuel to a fuel cell to generate electricity while the other may have a greater or lesser purity for the primary use of the hydrogen product. Hydrogen for use in fuel cells such as PEM fuel cells, typically must have a very low concentration of carbon monoxide, a poison for the fuel cells. But fuel cells can tolerate the presence of nitrogen and carbon dioxide. The primary use of the hydrogen may have much different purity requirements. Hydrogen for electronic use, for instance, has to be highly pure and even nitrogen is not tolerated. Whereas for float glass, annealing and some chemical processes, the presence of hydrogen and some carbon oxides may be acceptable. The primary use of the hydrogen may be for storage for subsequent refueling of vehicles using hydrogen as fuel.

In a preferred aspect, the hydrogen generator of this invention can readily be operated to accommodate changes in demand for hydrogen for the primary use while still enabling the reformer to operate at a given production level, or alternatively or in addition, to facilitate a turn up or turn down in hydrogen production by the reformer. In this preferred aspect, the amount of hydrogen that is withdrawn as permeate in the membrane separator is changed by changing at least one of the pressure drop and flow rate of effluent to the membrane separator thereby affecting the split between the hydrogen product of the first purity and the hydrogen product of the second purity. While the rate of electricity generation by the fuel cell will fluctuate, those changes are capable of being easily accommodated. For instance, if the fuel cell is associated with an electrical power grid, the excess electrical power can be placed in the grid or it can be used for other purposes. Where the electricity generated by the fuel cell is used to power the hydrogen generator, external power, such as from a power grid or battery, can be used to supplement internal needs for electrical power where the demand for the primary hydrogen product results in a shortage of hydrogen product for the fuel cell.

The broad aspects of the process of this invention for generating hydrogen and electrical power comprise:
a. reforming under catalytic reforming conditions including elevated temperature and the presence of steam a fuel to produce a reformate containing hydrogen, steam, carbon monoxide and carbon dioxide;
b. contacting at a pressure substantially no greater than that of the reformate of step a at least a portion of the reformate with a membrane selective for the permeation of hydrogen as compared to steam, carbon monoxide and carbon dioxide under permeation conditions including a temperature sufficient to prevent condensation of steam to permeate up to about 50 mole percent of the hydrogen contained in the portion of the reformate contacting the membrane to provide a first hydrogen product and to provide a retentate fraction;
c. subjecting the retentate fraction and any portion of the reformate not subjected to step b to pressure swing sorption to provide a second hydrogen product containing at least about 90 volume percent hydrogen and a purge fraction; and
d. reacting at least a portion of one of the first hydrogen product and the second hydrogen product in a fuel cell to produce electricity and providing the other of the first hydrogen product and the second hydrogen product as a primary hydrogen product.

In a preferred aspect of the invention, the reformate is split into a permeator feed fraction and a retained reformate fraction, said permeator feed fraction comprising up to about 50 volume percent of the reformate, and is the portion of the reformate contacting the membrane of step b. In further preferred aspects of the processes of the invention, the first hydrogen product is reacted in a fuel cell and first hydrogen product contains less than about 20 ppmv carbon monoxide.

The broad aspects of this invention relating to a process for controlling the volume of hydrogen production comprise:
a. reforming under catalytic reforming conditions including elevated temperature and the presence of steam a fuel to produce a reformate containing hydrogen, steam, carbon monoxide and carbon dioxide;
b. contacting at a pressure substantially no greater than that of the reformate of step a at least a portion of the reformate with a membrane selective for the permeation of hydrogen as compared to steam, carbon monoxide and carbon dioxide under permeation conditions including a temperature sufficient to prevent condensation of steam to permeate up to about 50 mole percent of the hydrogen contained in the portion of the reformate contacting the membrane to provide a first hydrogen product and to provide a retentate fraction;
c. subjecting the retentate fraction and any portion of the reformate not subjected to step b to pressure swing sorption to provide a second hydrogen product containing at least about 90 volume percent hydrogen and a purge fraction;
d. reacting at least a portion of one of the first hydrogen product and the second hydrogen product in a fuel cell to produce electricity and providing the other of the first hydrogen product and the second hydrogen product as a primary hydrogen product;
e. determining the demand for the primary hydrogen product; and
f. providing a driving force for the permeation of hydrogen in step b sufficient to permeate an amount of hydrogen such that the primary hydrogen product is in an amount substantially equivalent to the demand.

The driving force may be adjusted by any suitable means including adjusting the absolute pressure drop across the membrane, and by changing the flow rate of the reformate per unit of membrane surface area. By any of these methods, a change in flow rate of primary hydrogen product can be achieved.

The hydrogen generators of this invention, in the broad aspects, comprise:
a. a reformer containing reforming catalyst and adapted to provide under catalytic reforming conditions including elevated temperature and the presence of steam a fuel a reformate containing hydrogen, steam, carbon monoxide and carbon dioxide;
b. a membrane separator having a retentate side and a permeate side wherein the retentate side is in fluid communication with the reformate splitter to receive at least a portion of the reformate for contact with a membrane selective for the permeation of hydrogen as compared to steam, carbon monoxide and carbon dioxide to provide on the permeate side a first hydrogen product and on the retentate side a retentate;
c. a pressure swing sorption system in fluid communication with the reformer and adapted to receive reformate and in fluid communication with the retentate side of the membrane separator, said pressure swing sorption system being adapted to provide a second hydrogen product containing at least about 90 volume percent hydrogen and a purge fraction; and
d. a fuel cell in fluid communication with one of the permeate side of the membrane separator and the pressure swing sorption system, adapted to generate electricity by reacting hydrogen.

The apparatus preferably further comprises a reformate splitter in fluid flow communication with the reformer for receiving reformate adapted to provide a permeator feed fraction in fluid communication with the retentate side of the membrane separator and a retained reformate fraction in fluid communication with the pressure swing sorption system. In yet another preferred aspect of the invention, the apparatus comprises at least one water gas shift reactor in fluid communication with and located between the reformer and the pressure swing sorption assembly.

### BRIEF DESCRIPTION OF THE DRAWINGS

FIG. 1 is a schematic representation of a hydrogen generator of this invention in which the reformate splitter is positioned between the reformer and a water gas shift reactor and the retentate from the permeator is returned downstream of the splitter but before the water gas shift reactor.

FIG. 2 is a schematic representation of a hydrogen generator of this invention in which the reformate splitter is positioned downstream of a water gas shift reactor and the retentate from the permeator is returned downstream of the splitter.

FIG. 3 is a schematic representation of a hydrogen generator similar to that depicted in FIG. 2 but with the permeate being subjected to a low temperature water gas shift prior to being recombined with the retained fraction from the splitter.

FIG. 4 is a schematic representation of a hydrogen generator similar to that depicted in FIG. 2 in which two water gas shift reactors are employed.

### DETAILED DISCUSSION

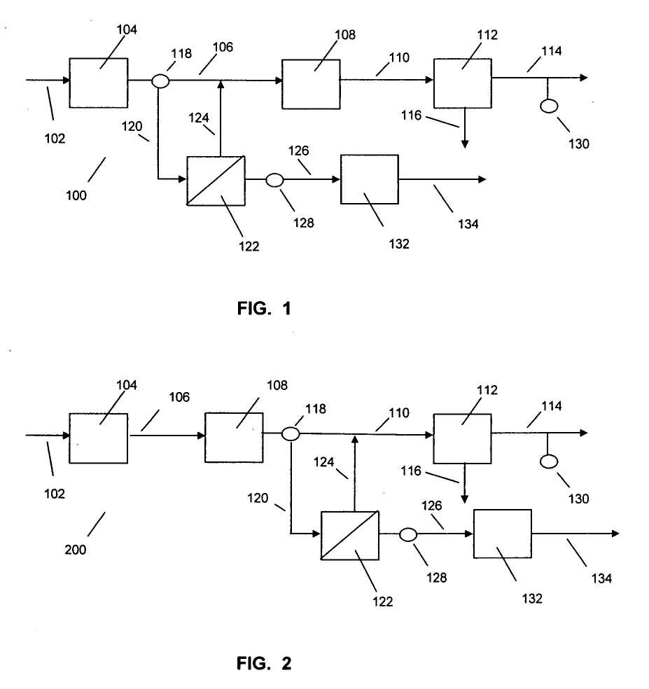

With reference to FIG. 1, reforming feed is provided through one or more lines 102 to reformer 104. The feeds to a reformer will depend upon the type of reforming to be effected, which may be partial oxidation, autothermal reforming (ATR) or steam reforming. For partial oxidation and ATR reforming, the feed will include an oxygen source such as air, oxygen-enriched air or substantially pure oxygen. Typically where an oxygen source is required, it is air or oxygen-enriched air, e.g., up to about 90, more frequently, up to about 50, volume percent free oxygen. The amount of oxygen provided for partial oxidation and ATR reforming will again be dependent on the type of reforming process. For ATR, the amount of oxygen is sufficient to generate sufficient heat through combustion to maintain desired reforming temperatures. For partial oxidation reforming, the amount of oxygen will be based on stoichiometry. Preferably, the reforming is partial oxidation reforming, and more preferably ATR, using air as the oxygen source.

The fuel for reforming may be any suitable hydrocarbon-containing component and are typically gaseous under the conditions of reforming. Lower hydrocarbon gases such as methane, ethane, propane, butane and the like may be used. Because of availability, natural gas and liquid petroleum gas (LPG) are most often used as feeds. Oxygenated hydrocarbon-containing feeds such as methanol and ethanol are included as hydrocarbon-containing feeds for all purposes herein.

Natural gas and liquid petroleum gas typically contain odorants such that leaks can be detected. Odorants conventionally used are one or more organosulfur compounds such as organosulfides, e.g., dimethyl sulfide, diethyl sulfide, and methyl ethyl sulfide; mercaptans, e.g., methyl mercaptan, ethyl mercaptan, and t-butyl mercaptan; thiophenes of which tetrahydrothiophene is the most common; and the like. The amount used can vary widely. For natural gas, the organosulfur component is often in the range of about 1 to 20 parts per million by volume (ppmv); and for LPG a greater amount of sulfur compounds are typically used, e.g., from about 10 to 200 ppmv. It is not unusual for commercially obtained hydrocarbon feeds to contain also other sulfur compounds which may be natural impurities such as hydrogen sulfide and carbonyl sulfide. Carbonyl sulfide concentrations in natural gas and LPG of 0.1 to 5 ppmv are not unusual. Regardless of the form of the sulfur, it can be deleterious to catalysts used in hydrogen generators and to fuel cells. Accordingly, the feed should be desulfurized. Any convenient desulfurization technique may be used including sorption and hydrodesulfurization. Desulfurization may, if desired, be effected on the reformer effluent since reforming catalysts do exist that can tolerate some amount of sulfur. One advantage of conducting the desulfurization after reforming is that the reforming reactions convert sulfur components into hydrogen sulfide.

The feeds can contain other impurities such as carbon dioxide, nitrogen and water. In the processes of this invention, it is preferred that the concentration of carbon dioxide in the feed be less than about 5, preferably less than about 2, volume percent.

The pressure in the reforming conditions of the processes of this invention is at least about 400 kPa, say from about 500 kPa to 1500 or 2500 kPa, preferably from about 500 kPa to about 1200 kPa, absolute. Thus the reforming conditions comprise a pressure suitable for the operation of the pressure swing sorption system and the membrane separator without an intervening compression. The reforming may be via steam reforming alone or may be effected by partial oxidation or by a combination of partial oxidation of the fuel being passed to the reformer and steam reforming (ATR). Steam reforming is a catalytic reaction producing hydrogen and carbon oxides (carbon dioxide and carbon monoxide) conducted under steam reforming conditions. Steam reforming conditions usually comprise temperatures in excess of 600° C., e.g., 600° C. to 1000° C.

Partial oxidation reforming conditions typically comprise a temperature of from about 600° C. to about 1000° C., preferably about 600° C. to 800° C. The partial oxidation reforming is catalytic. The overall partial oxidation and steam reforming reactions for methane are expressed by the formulae:

CH₄+0.5O₂→CO+2H₂

CH₄+H₂O [symbol] CO+3H₂

The reformer may comprise two discrete sections, e.g., a first contact layer of oxidation catalyst followed by a second layer of steam reforming catalyst, or may be bifunctional, i.e., oxidation catalyst and steam reforming catalyst are intermixed in a single catalyst bed or are placed on a common support. The partial oxidation reformate comprises hydrogen, nitrogen (if air is used as the source of oxygen), carbon oxides (carbon monoxide and carbon dioxide), steam and some unconverted hydrocarbons.

The reformate contains hydrogen, carbon dioxide and carbon monoxide as well as water. On a dry basis, the components of the effluent from the reformer fall within the ranges set forth below:

REFORMER EFFLUENT COMPONENTS, MOLE PERCENT DRY
BASIS

| Component | Steam Reforming | Autothermal Reforming |
|---|---|---|
| Hydrogen | 50 to 80, | 35 to 60, frequently 40 to 45 |
| | frequently 70 to 75 | |
| Nitrogen | 0 to 3, | 10 to 40, frequently 20 to 35. |
| | frequently 0 to 1 | and for air, frequently 30 to 35 |
| Carbon monoxide | 3 to 15, | 3 to 15, frequently 3 to 10, |
| | frequently 5 to 10 | and for air, frequently 3 to 6 |
| Carbon dioxide | 10 to 25, | 10 to 25, frequently 12 to 20, |
| | frequently 15 to 20 | and for air, 12 to 15 |

As shown in FIG. 1, the reformate exits reformer 104 via line 106. Line 106 contains splitter 118 which directs a portion of the reformer effluent to a membrane separator, to be discussed later, and which directs another portion to water gas shift reactor 108. In the broad aspects of this invention, a splitter is not required in that the entire reformate stream may be directed to the membrane separator. Where a splitter is used, generally from about 10 to 90, often from about 10 to 50, volume percent of the reformate is directed to the membrane separator. The relative portion of the split may vary, as stated above, to change the relative portions of the first hydrogen product and the second hydrogen product.

A water gas shift reactor is optional with respect to the broad aspects of the invention. The advantage of a water gas shift is that carbon monoxide and water are reacted to not only reduce the concentration of carbon monoxide in the reformate but also to generate more hydrogen. In the shift reactor 108 carbon monoxide is exothermically reacted in the presence of a shift catalyst in the presence of an excess amount of water to produce additional amounts of carbon dioxide and hydrogen. The shift reaction is an equilibrium reaction. The reformate exiting a shift reactor thus has a reduced carbon monoxide content.

Although any number of water gas shift reaction zones may be employed to reduce the carbon monoxide level in the hydrogen product, the preferred processes of this invention using pressure swing adsorption for hydrogen purification use only a high temperature shift at high temperature shift conditions comprising temperatures between about 320° C. and about 450° C. As the hydrogen-containing stream is purified by pressure swing adsorption, the use of more stages of water gas shift or selective oxidation to further reduce the amount of carbon monoxide unduly increases the expense and complexity of the hydrogen generator.

In the broader aspects of the invention, other carbon monoxide reducing unit operations may be used such as low temperature shift and selective oxidation to preferentially oxidize carbon monoxide to carbon dioxide without undue combustion of hydrogen.

The effluent from water gas shift reactor 108 is passed via line 110 to pressure swing sorption system 112. The effluent from water gas shift reactor 108 will also contain water and will typically be at a temperature higher than that most advantageous for pressure swing adsorption. Accordingly, the stream is cooled to a temperature below about 100° C., preferably to a temperature in the range of about 300 to 80° C., and most preferably to about 35° to 65° C. Under these conditions, water will be condensed and can be removed from the stream.

The reformate is provided at an elevated pressure suitable for pressure swing adsorption operation without additional compression. If desired, additional compression may be effected.

Desirably the pressure swing adsorption provides a hydrogen product stream (the second hydrogen product) containing at least about 90, preferably at least about 98, preferably at least about 99, volume percent. The content of impurities in the second hydrogen product will depend upon the intended use of the product. For use as a feed to a fuel cell, it typically will contain less than about 20 ppmv carbon monoxide. For annealing and float glass use, the second hydrogen product may contain nitrogen and some minor amounts, preferably less than about 1, more preferably less than about 0.5, volume percent carbon monoxide. For electronics use, the second hydrogen product should have a purity of at least about 99.999 percent including a nitrogen content of less than about 10, preferably less than about 1, ppmv. Usually the pressure swing adsorption recovers at least about 65, preferably at least about 80, percent of the hydrogen contained in the stream fed to the pressure swing adsorption.

Any suitable adsorbent or combination of adsorbents may be used for the pressure swing adsorption. The particular adsorbents and combinations of adsorbents used will, in part, depend upon the components of the feed to the pressure swing adsorber, the sought compositions in the purified hydrogen product and the geometry and type of pressure swing adsorber used. Adsorbents include molecular sieves including zeolites, metal oxide or metal salt, and activated carbon. Particularly advantageous sorbents include a combination of sorbents with the first portion of the bed being composed of activated carbon which is particularly effective for water and carbon dioxide removal followed by one or more molecular sieves such as NaY, 5 A, lithium or barium exchanged X, silicalite and ZSM-5.

The pressure swing adsorber may be of any suitable design including rotary and multiple bed. The purging of the bed may be by vacuum, but most conveniently for simplicity, the purge is above ambient atmospheric pressure. A preferred pressure swing adsorption system for low maintenance operation uses at least four fixed beds. By sequencing the beds through adsorption and regeneration steps, a continuous flow of purified hydrogen stream can be achieved without undue loss of hydrogen. With at least four beds, one bed at a given time will be adsorbing, another will be providing purge, another will be undergoing purging and another will be undergoing repressurization.

The operation of the pressure swing adsorber will also be influenced by the cycle time and the ratio of the pressures for the swing. The purge usually occurs within about 100, preferably within about 50, say, 10 to 50, kPa above ambient atmospheric pressure. The cycle times are selected to provide the hydrogen product of a desired purity. For a given pressure swing adsorber system, as the cycle times become shorter, the purity achievable increases, but also, less hydrogen is recovered. Thus, the cycle times and adsorber sizing can be selected for a given unit based upon the hydrogen specification and sought recovery.

Line 116 withdraws a purge from pressure swing sorption system 112. This purge usually contains some hydrogen and can be combusted to provide heat within the hydrogen generator, e.g., by preheating one or more of the feeds, generating stream, or providing indirect heat to reformer 104, or used elsewhere. The primary hydrogen product is withdrawn from pressure swing sorption system via line 114 and may be used for any suitable purpose such as a chemical reaction, providing annealing atmospheres, and the like.

The processes and apparatus of this invention use a membrane to provide the first hydrogen product. The retentate from the membrane separation is thereafter subjected to the pressure swing sorption. Since the retentate is at substantially the same pressure as the feed to the permeator, the retentate need not be compressed. Preferably substantially all the reformate is passed to the permeate. Where it is desired to only subject a portion of the reformate to the membrane separation process, a splitter can be used as is shown in FIG. 1. In splitter 118, a portion of the reformate (permeator feed fraction) is withdrawn via line 120. Splitter 118 may be any suitable devise adapted to divide the reformate stream. It may be a fixed splitter or variable splitter such as a controllable valve.

The permeator feed fraction is introduced into permeator 122 which contains a selectively permeable membrane. The membrane may be of any suitable type provided that it exhibits sufficient selectivity. The variety of membrane materials range from metallic membranes such as vanadium, tantalum, niobium, and palladium and alloys of such elements to organic membranes such as polysulfone, polyamide, polyimide, polycarbonate, polyketone, and the like membranes. The purity of the first hydrogen product will depend in part upon the membrane selected. Highly selective metal membranes can provide a hydrogen product suitable for electronics use as well as for fuel cell and chemical, annealing and float glass operations. Preferably, where the permeate is used as a feed to a fuel cell, the permeate contains less than about 20 ppmv carbon monoxide.

The permeator feed fraction contacting the membrane is preferably under conditions such that steam does not condense. Depending upon the type of membrane, the temperature of the permeator feed may need to be adjusted. Typically the metallic membranes use elevated temperatures, e.g., from about 200° to 700° C. or more, to achieve attractive permeation rates. Advantageously, the effluent from reformer 104 may be at temperatures suitable for use with metallic membranes. If polymeric membranes are to be used, the temperature of the permeator feed fraction generally must be reduced to prevent damage to the membrane, e.g., to 175° C. or less. Polymeric membranes typically have much lower hydrogen selectivity than do metallic membranes. Consequently, the first hydrogen product may be the primary hydrogen product for annealing, chemical process feedstocks and the like where greater amounts of impurities such as carbon monoxide may be tolerable. However, fuel cells exist that have greater resistance to carbon monoxide poisoning, and the permeate provided by a less selective polymeric membrane may be quite acceptable for these types of fuel cells.

The membranes in permeator 122 may be of any suitable design including flat, spiral wound and hollow fiber. The permeator may be designed to provide flow patterns of the permeator feed fraction and the retentate co-current, cross-current or counter-current.

A partial pressure driving force is used to effect permeation of hydrogen through the membrane. Accordingly, a pressure differential is maintained across the membrane. Often the pressure differential is at least about 200, preferably at least about 300, kPa, and sometimes in the range of 300 to 2000 kPa. The hydrogen partial pressure is a function of the mole fraction of hydrogen and the pressure.

In accordance with this invention, only a portion, i.e., up to about 50 mole percent of the hydrogen contained in the permeator feed fraction is permeated. Thus, a substantial partial pressure of hydrogen in on the retentate side of the membrane is maintained. Often, the portion of the hydrogen contained in the permeator feed fraction that is permeated is within the range of about 2 to 50, more frequently between about 3 and 35, and sometimes between about 3 and 25, mole percent. The fact that only a small fraction of the hydrogen permeates does not render the process of this invention economically unattractive in that the retentate remains at high pressure and can thus be recombined with the retained fraction of the reformate. Moreover, the maintenance of a high hydrogen partial pressure on the retentate side of the membrane enables reduced membrane surface area to be used for a given amount of permeation of hydrogen.

In the control system of the invention where the amount of hydrogen permeated changes to control the rate of primary hydrogen production, the rate of permeation of hydrogen can be affected by either or both of a change in pressure differential across the membrane and the rate reformate is provided to the membrane per unit surface area. At higher rates of feed, the partial pressure on the retentate side of the membrane will remain higher, thereby increasing the rate of permeation of hydrogen, all other things remaining the same. The rate change may also be effected by adding or subtracting membrane surface area, e.g., putting on or taking off membrane modules.

The retentate is passed from permeator 122 via line 124 for recombination with the remaining fraction in line 106. The permeate is passed via line 126 to fuel cell assembly 132. Electricity is withdrawn from fuel cell assembly via line 134. Alternatively, the second hydrogen product can be used as the feed to the fuel cell.

As shown, line 126 from permeator 122 is provided with pressure control valve 128. Also, hydrogen product demand sensor 130 is provided to determine the rate of primary hydrogen product required. In one mode of operation, pressure control valve 128 and splitter 118 are in communication with hydrogen product demand sensor 130 such that the flow rate of the permeate feed fraction to permeator 122 and the pressure differential across the membrane can be controlled.

If desired, a compressor can be provided in line 120 and hydrogen product demand sensor 130 can be in communication with the compressor to change the pressure differential across the membrane.

FIG. 2 is another hydrogen generator generally designated by the numeral 200. In FIG. 2, the same designation number has been given to the same components as in FIG. 1, and to the extent that these components are the same, the discussion above is incorporated herein.

In FIG. 2, splitter 118 is subsequent to water gas shift reactor 108. This embodiment is particularly attractive for the use of polymeric membranes in permeator 122. First, the water gas shift equilibrium is temperature affected. Consequently, the temperature of the effluent gases from the water gas shift reactor may be at a temperature suitable for a polymeric membrane. Moreover, it is usually desirable to reduce the temperature of the effluent from the water gas shift reactor prior to introduction into the pressure swing sorption system. Splitter 118 can be positioned downstream of such cooling.

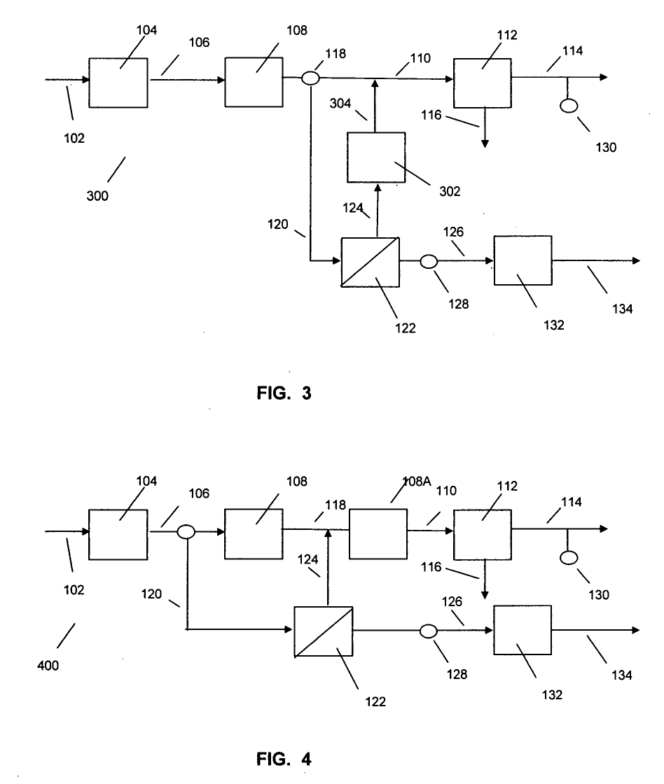

The hydrogen generator 300 of FIG. 3 is similar to that of FIG. 2 except that low temperature water gas shift reactor 302 receives retentate from permeator 122 via line 124. As the retentate is enriched with carbon monoxide in permeator 122, low temperature shift reactor 302 can provide additional hydrogen in an advantageous manner. Effluent from low temperature shift reactor 302 is passed vial line 304 for recombination with the retained fraction in line 110 for passage to pressure swing sorption system 112.

The hydrogen generator 400 of FIG. 4 is similar to that of FIG. 1 except that the flow to and from permeator 122 via lines 120 and 124 straddle water gas shift reactor 108, which for purposes of this illustration is a high temperature shift reactor. The combined reformate from water gas shift reactor 108 and retentate from permeator 122 are combined and introduced into low temperature shift reactor 108A. The effluent from low temperature shift reactor 108A is passed to pressure swing sorption system 112. The water gas shift reaction is an equilibrium reaction affected by temperature. The low temperature water gas shift will serve to further reduce the carbon monoxide content of the reformate. As the retentate contains an increased concentration of carbon monoxide due to the selective permeation of some of the hydrogen, the recombined stream has a higher concentration of carbon monoxide than the effluent from water gas shift reactor 108 and hence the efficiency of production of hydrogen by water gas shift reactor 108A is enhanced.

It is claimed:

1. A process for generating hydrogen and electrical power comprising:
a. reforming under catalytic reforming conditions including elevated temperature and the presence of steam and fuel to produce a reformate containing hydrogen, steam, carbon monoxide and carbon dioxide;
b. contacting at a pressure substantially no greater than that of the reformate of step a at least a portion of the reformate with a membrane selective for the permeation of hydrogen as compared to steam, carbon monoxide and carbon dioxide under permeation conditions including a temperature sufficient to prevent condensation of steam to permeate up to about 50 mole percent of the hydrogen contained in the portion of the reformate contacting the membrane to provide a first hydrogen product and to provide a retentate fraction;
c. subjecting the retentate fraction and any portion of the reformate not subjected to step b to pressure swing sorption to provide a second hydrogen product containing at least about 90 volume percent hydrogen and a purge fraction; and
d. reacting at least a portion of one of the first hydrogen product and the second hydrogen product in a fuel cell to produce electricity and providing the other of the first hydrogen product and the second hydrogen product as a primary hydrogen product.

2. The process of claim 1 wherein substantially all of the reformate is subjected to step b.

3. The process of claim 1 wherein the reformate is split into a permeator feed fraction and a retained reformate fraction, said permeator feed fraction comprising up to about 50 volume percent of the reformate, and is the portion of the reformate contacting the membrane of step b.

4. The process of claim 3 wherein the first hydrogen product is reacted in a fuel cell and the first hydrogen product contains less than about 20 ppmv carbon monoxide.

5. The process of claim 3 wherein the reformate is subjected to water gas shift conditions to provide a shift effluent containing an increased concentration of hydrogen and a reduced concentration of carbon monoxide.

6. The process of claim 3 wherein step b is prior to subjecting the reformate to water gas shift conditions.

7. The process of claim 3 wherein step b is subsequent to subjecting the reformate to water gas shift conditions.

8. A process for controlling the volume of hydrogen production from a hydrogen generator comprising:
a. reforming under catalytic reforming conditions including elevated temperature and the presence of steam and fuel to produce a reformate containing hydrogen, steam, carbon monoxide and carbon dioxide;
b. contacting at a pressure substantially no greater than that of the reformate of step a at least a portion of the reformate with a membrane selective for the permeation of hydrogen as compared to steam, carbon monoxide and carbon dioxide under permeation conditions including a temperature sufficient to prevent condensation of steam to permeate up to about 50 mole percent of the hydrogen contained in the portion of the reformate contacting the membrane to provide a first hydrogen product and to provide a retentate fraction;
c. subjecting the retentate fraction and any portion of the reformate not subjected to step b to pressure swing sorption to provide a second hydrogen product containing at least about 90 volume percent hydrogen and a purge fraction;
d. reacting at least a portion of one of the first hydrogen product and the second hydrogen product in a fuel cell to produce electricity and providing the other of the first hydrogen product and the second hydrogen product as a primary hydrogen product;
e. determining the demand for the primary hydrogen product; and
f. providing a driving force for the permeation of hydrogen in step b sufficient to permeate an amount of hydrogen such that the primary hydrogen product is in an amount substantially equivalent to the demand.

9. The process of claim 8 wherein the absolute pressure drop across the membrane is used to provide the sought driving force for step f.

10. The process of claim 8 wherein the flow rate of the reformate per unit area of membrane is used to provide the sought driving force for step f.

11. The process of claim 8 wherein the first hydrogen product is reacted in a fuel cell and first hydrogen product contains less than about 20 ppmv carbon monoxide.

12. A hydrogen generator comprising:
a. a reformer containing reforming catalyst and adapted to provide under catalytic reforming conditions including elevated temperature and the presence of steam and fuel, a reformate containing hydrogen, steam, carbon monoxide and carbon dioxide;
b. a membrane separator having a retentate side and a permeate side wherein the retentate side is in fluid communication with the reformate splitter to receive at least a portion of the reformate for contact with a membrane selective for the permeation of hydrogen as compared to steam, carbon monoxide and carbon dioxide to provide on the permeate side a first hydrogen product and on the retentate side a retentate;
c. a pressure swing sorption system in fluid communication with the reformer and adapted to receive reformate and in fluid communication with the retentate side of the membrane separator, said pressure swing sorption system being adapted to provide a second hydrogen product containing at least about 90 volume percent hydrogen and a purge fraction; and
d. a fuel cell in fluid communication with one of the permeate side of the membrane separator and the pressure swing sorption system, adapted to generate electricity by reacting hydrogen.

13. The hydrogen generator of claim 12 further comprising a reformate splitter in fluid flow communication with the reformer for receiving reformate adapted to provide a permeator feed fraction in fluid communication with the retentate side of the membrane separator and a retained reformate fraction in fluid communication with the pressure swing sorption system.

14. The hydrogen generator of claim 12 further comprising a water gas shift reactor in fluid flow communication between the reformer and the pressure swing sorption system.

15. The hydrogen generator of claim 14 in which the reformate splitter is positioned between the reformer and the water gas shift reactor.

16. The hydrogen generator of claim 14 in which the reformate splitter is positioned between the water gas shift reactor and the pressure swing sorption system.

17. The hydrogen generator of claim 16 further comprising a low temperature water gas shift reactor positioned between the membrane separator and the pressure swing sorption system and in fluid communication with the retentate side of the membrane separator.
